(19) United States
(12) Patent Application Publication
(10) Pub. No.: US 2012/0273389 A1
(43) Pub. Date: Nov. 1, 2012

(54) SEMICONDUCTOR TRAY CARRIER

(75) Inventors: Muhammad Rizal Abdul Aziz, Petaling Jaya (MY); Hashim Muhammad, Shah Alam (MY); Musa B. Rajak, Kuala Lumpur (MY); Maruthaimuthu Sithambaram, Banting (MY); Chong Beng Soon, Mont Kiara (MY); Sea Hong Tan, Kuala Lumpur (MY)

(73) Assignee: FREESCALE SEMICONDUCTOR, INC., Austin, TX (US)

(21) Appl. No.: 13/443,906

(22) Filed: Apr. 11, 2012

(30) Foreign Application Priority Data
Apr. 27, 2011 (MY) PI2011001861

(51) Int. Cl. B65D 85/00; B23P 19/04; B65B 7/28; B65G 65/00

(52) U.S. Cl. 206/710; 414/800; 29/428; 53/396; 53/485

(57) ABSTRACT

A semiconductor tray carrier has a base part and first and second side parts. The first and second side parts are movable between a stowed position and a deployed position in which the side parts extend from the base part to form side walls. Multiple tray carriers can be stacked one upon the other when the side walls are in either the stowed or deployed positions. When stacked in the stowed position, the tray carriers require very little storage space. Windows are provided for attaching details on the contents of the tray carriers.

### BACKGROUND OF THE INVENTION

The present invention relates to a semiconductor tray carrier, a method of forming a semiconductor tray carrier, and a method of packing a semiconductor tray carrier.

In the semiconductor assembly industry, semiconductor devices, such as lead frame assemblies or substrate packages are commonly transported in semiconductor trays. These semiconductor trays typically comprise storage areas for receiving multiple semiconductor devices, which are then packed within semiconductor tray carriers for storage and transportation.

Conventional semiconductor tray carriers typically have a box-like construction with an internal volume for the storage of semiconductor trays. That is, they are shaped as a fixed, generally rectangular cuboid and also usually have a lid. The box, base, side walls and lid box define the internal volume. Conventional semiconductor tray carriers have several drawbacks in their design and construction. For instance, the lid is arranged to open and close in conventional fashion, typically with a hinge external the box. Since it is external to the box, the hinge is prone to damage. Locks are also sometimes provided and they too are located on the outside of the box, so are also prone to damage.

Given the rigid box-like construction of conventional semiconductor tray carriers, they require a significant amount of storage space, something which is a particular drawback when they are empty because floor space in a semiconductor assembly facility is at a premium, and much of the space required to store empty tray carriers is wasted space.

Additionally, conventional semiconductor tray carriers are typically constructed of corrugated plastic, a material which is susceptible to damage.

Conventional semiconductor tray carriers also present other drawbacks including that the electrostatic discharge properties of the corrugated plastic material deteriorates relatively rapidly over time; if any boxes are damaged they require replacement as repair may not be easily effected, and friction of the external box surface against, for example shelving units upon which the semiconductor tray carriers are stored may cause or trap excessive dust.

Thus, it would be advantageous to develop a new semiconductor tray carrier that alleviates the aforementioned problems.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is an elevational view illustrating a semiconductor tray carrier in accordance with an embodiment of the present invention;

FIG. 2 is a perspective view illustrating the semiconductor tray carrier of FIG. 1;

FIG. 3A is a perspective view illustrating the semiconductor tray carrier of FIG. 1 and the manner in which the side parts thereof may be disposed in stowed and deployed positions;

FIG. 3B is a second perspective view illustrating the semiconductor tray carrier of FIG. 1 and the manner in which the side parts thereof may be disposed in stowed and deployed positions;

FIG. 4A is a perspective view illustrating the base part of the semiconductor tray carrier of FIG. 1;

FIG. 4B is a second perspective view illustrating the base part of the semiconductor tray carrier of FIG. 1;

FIG. 5A is a perspective view illustrating a side part of the semiconductor tray carrier of FIG. 1;

FIG. 5B is a second perspective view illustrating a side part of the semiconductor tray carrier of FIG. 1;

FIG. 6A is a perspective view illustrating details of components of the base part of the semiconductor tray carrier of FIG. 1;

FIG. 6B is a second perspective view illustrating details of components of the base part of the semiconductor tray carrier of FIG. 1;

FIG. 7 is a perspective view illustrating stacking of semiconductor tray carriers in accordance with the embodiment of FIG. 1;

FIG. 8A is a perspective view illustrating packing of semiconductor trays in the semiconductor tray carrier of FIG. 1; and

FIG. 8B is a second perspective view illustrating packing of semiconductor trays in the semiconductor tray carrier of FIG. 1.

### DETAILED DESCRIPTION OF THE INVENTION

In one embodiment, the present invention provides a semiconductor tray carrier including a base part, a first side part arranged to move between a first, stowed position and a first, deployed position in which the first side part extends from the base part to form a first side wall part, and a second side part arranged to move between a second, stowed position and a second, deployed position in which the second side part extends from the base part to form a second side wall part.

In another embodiment, the present invention provides a method of making a semiconductor tray carrier. The method includes the steps of providing a base part, providing a first side part, providing a second side part, and mechanically coupling the first side part with the base part, with the first side part being movable between a first stowed position and a first deployed position in which the first side part extends from the base part to form a first side wall. The method also includes a step of mechanically coupling the second side part with the base part, the second side part being movable between a second stowed position and a second deployed position in which the second side part extends from the base part to form a second side wall.

In another embodiment, the present invention provides a method of packing semiconductor trays in a semiconductor tray carrier, where the semiconductor tray carrier comprises: a base part; a first side part arranged to move between a first stowed position and a first deployed position in which the first side part extends from the base part to form a first side wall part; and a second side part arranged to move between a second stowed position and a second deployed position in which the second side part extends from the base part to form a second side wall part; the method comprising: moving the first side part to the first deployed position and the second side part to the second deployed position, the base part, first side wall part and second side wall part defining a carrier volume for carrying semiconductor trays; and placing a plurality of semiconductor trays within the carrier volume.

Also disclosed is a semiconductor tray carrier comprising: a base part having a first generally planar portion for a semiconductor tray to be disposed thereon; a first side part coupled with the base part at a first hinge (or pivot), the first side part having a second generally planar portion forming a first side wall; and a second side part coupled with the base part at a second hinge (or pivot), the second side part having a third generally planar portion forming a second side wall; wherein each of the first and second side parts is collapsible towards the base part about the first and second hinges (or pivots) respectively to lie in respective stowed positions, wherein, in the stowed positions, the first generally planar portion, the second generally planar portion and the third generally planar portion all lie in planes generally parallel to one another.

Implementation of embodiments of the invention may provide significant technical benefits in comparison with conventional techniques. For instance, provision of a semiconductor tray carrier having side parts arranged to move between a stowed position and a deployed position in which the side parts extend from the base part to form side wall parts, may provide significant advantages in terms of space-saving for storage of semiconductor tray carriers when not in use. That is, empty semiconductor tray carriers not in use may have their side walls or wall parts “folded” or “collapsed” down to take up significantly less volume than conventional semiconductor tray carriers. This may be a particularly beneficial arrangement where one or more of the side parts is arranged to lie in contact with the base part; the side part is then as close to the base part as possible, thereby minimizing the height of the semiconductor tray carrier when in this configuration.

Further, in embodiments of the invention where the side parts are formed separately from the base part and subsequently assembled together, improved flexibility for maintenance of the semiconductor tray carriers may be realized. For example, if a side part becomes damaged, it can simply be removed and replaced with a non-damaged spare part. This provides a significant improvement over the conventional semiconductor tray carrier which may require complete replacement should any of its component parts, such as a sidewall become damaged.

Additionally, in embodiments of the invention where the side wall parts are arranged to move between stowed and deployed positions about a pivot, for example a hinge, the hinge or pivot can be provided “internal” to the carrier volume (explained in greater detail below) of the semiconductor tray carrier thereby minimizing chances of damage thereto which might otherwise occur if the hinge is accessible from external the semiconductor tray carrier.

Yet further, in embodiments of the invention where the component parts comprise molded plastic, the present invention provides a significant enhancement over conventional semiconductor tray carriers comprised of corrugated plastic material in terms of enhanced and/or prolonged electrostatic discharge performance.

In embodiments of the invention where one or more projections extend from an underside of the base part, the present invention allows for a significant part of the underside of the base part to be raised from, for example a storage shelf upon which the tray carrier rests thereby minimizing friction contact between the underside of the base part and that the storage shelf, minimizing accumulation and trapping of dust.

Additionally, where a part of the semiconductor tray carrier is arranged for engagement with another semiconductor tray carrier, this facilitates secure stacking of one semiconductor tray carrier upon another.

In embodiments of the invention where at least part of the semiconductor trays disposed within the semiconductor tray carrier are visible to an operator, such as when wall parts are provided on only two sides of the semiconductor tray carrier; this provides a significant advantage in that an operator can readily discern the extent to which the semiconductor tray carrier has been filled with semiconductor trays and whether or not the semiconductor trays have been stacked in an orderly manner. Such an advantage is not realized with conventional semiconductor tray carriers which, as mentioned above, are formed of a generally rectangular cuboid, having four side walls and a lid, which may be locked.

The terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to distinguish between the elements such terms describe. Thus, these terms are not necessarily intended to indicate temporal or other prioritization of such elements.

Because the apparatus implementing the present invention is, at least in part, composed of materials known to those skilled in the art, full details concerning these materials will not be explained in any greater extent than that considered necessary for the understanding and appreciation of the underlying concepts of the present invention and in order not to obfuscate or distract from the teachings of the present invention.

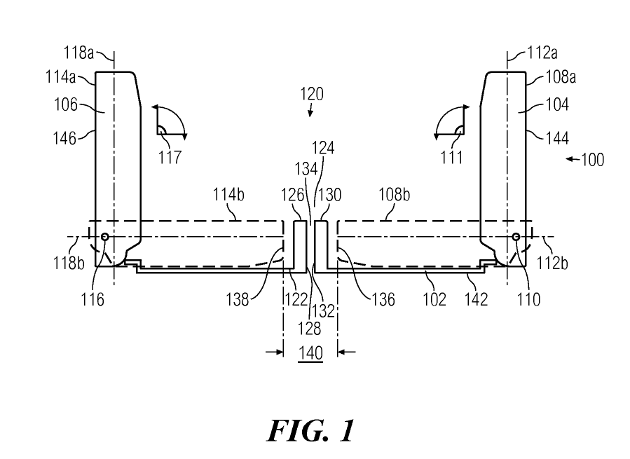

Some of the embodiments may be implemented using a variety of different arrangements. For example, although FIG. 1 and the discussion thereof describe a semiconductor tray carrier of a particular configuration, this exemplary semiconductor tray carrier is presented merely to provide a useful reference in discussing various aspects of the invention. Of course, the description of the semiconductor tray carrier has been simplified for purposes of discussion, and it is just one of many different types of appropriate semiconductor tray carriers that may be used in accordance with the invention. Those skilled in the art will recognize that the semiconductor tray carrier is merely illustrative and that the invention may encompass alternative embodiments or may impose an alternate composition of components or materials.

Further, those skilled in the art will recognize alternative embodiments may include multiple instances of a particular operation, and the order of operations may be altered in various other embodiments.

Referring now to FIG. 1, a semiconductor tray carrier 100 in accordance with an embodiment of the present invention is illustrated in elevational view. The semiconductor tray carrier 100 comprises a base part 102 of a generally planar configuration disposed upon a surface (not shown) of a storage device such as a shelving unit. The semiconductor tray carrier 100 also comprises a first side part 104 extending from base part 102 forming a first side wall part of the semiconductor tray carrier 100. The semiconductor tray carrier 100 further comprises a second side part 106, also extending from base part 102, and forming a second side wall part of the semiconductor tray carrier 100. As illustrated in FIG. 1, the first side part 104 is disposed in a first deployed position 108a. The first side part 104 is arranged to move between the first deployed position 108a and a first stowed position 108b illustrated in FIG. 1 in dashed lines. The first side part 104 is arranged to move between the first deployed position 108a and the first stowed position 108b about a pivot 110 across a range of angles 111. In the embodiment of FIG. 1, the range of angles 111 is approximately 90 degrees. That is, in this exemplary embodiment, in the deployed position 108a, the first side part 104 extends from the base part 102 in a vertical plane 112a at or around 90 degrees from a horizontal plane 112b. In the deployed position, the first side part 104 forms a side wall of the semiconductor tray carrier 100. In the stowed position 108b, the first side part 104 “collapses” or “folds” down about pivot 110 to lie in the horizontal plane 112b and, in this embodiment, in contact with the base part 102.

The second side part 106 is disposed in a second deployed position 114a. The second side part 106 is arranged to move between the second deployed position 114a and a second stowed position 114b illustrated in dashed lines. The second side part 106 is arranged to move between the second deployed position 114a and the second stowed position 114b about a pivot 116 across a range of angles 117. In the embodiment of FIG. 1, the range of angles 117 is approximately 90 degrees. That is, in the deployed position 114a, the second side part 106 extends from the base part 102 in a vertical plane 118a at or around 90 degrees from a horizontal plane 118b. In the deployed position, the side part 106 forms a second side wall of the semiconductor tray carrier 100. In the second stowed position 114b, the second side part 106 also “collapses” or “folds” down about the pivot 116 to lie in the horizontal plane 118b and, in this embodiment, also in contact with the base part 102.

Movement of the first and second side parts 104, 106 may be reversed, so that they move from the respective stowed positions 108b, 114b to the respective deployed positions 108a, 114b.

Therefore, in the embodiment of FIG. 1, there is illustrated a semiconductor tray carrier 100 comprising: a base part 102; a first side part 104 arranged to move between a first stowed position 108b and a first deployed position 108a in which the first side part 104 extends from the base part 102 to form a first side wall; and a second side part 106 arranged to move between a second stowed position 114b and a second deployed position 114a in which the second side part 106 extends from the base part 102 to form a second side wall.

In the embodiment of FIG. 1, horizontal planes 112b and 118b where the side parts 104, 106 lie in the stowed positions 108b, 114b are coplanar, but alternative arrangements are encompassed. For instance, in alternative embodiments, the semiconductor tray carrier 100 may be configured such that the respective side parts 104, 106 are disposed one on top of the other (not illustrated) in the respective stowed positions. In such alternative embodiments, the respective side parts 104, 106 may be disposed in planes that are parallel but displaced from one another.

The base part 102 and first and second side parts 104, 106 may be formed in an injection molding process. In one or more embodiments, these parts may be formed separately from one another. In one or more embodiments, the parts may be integrally molded with one another, discussed in further detail below.

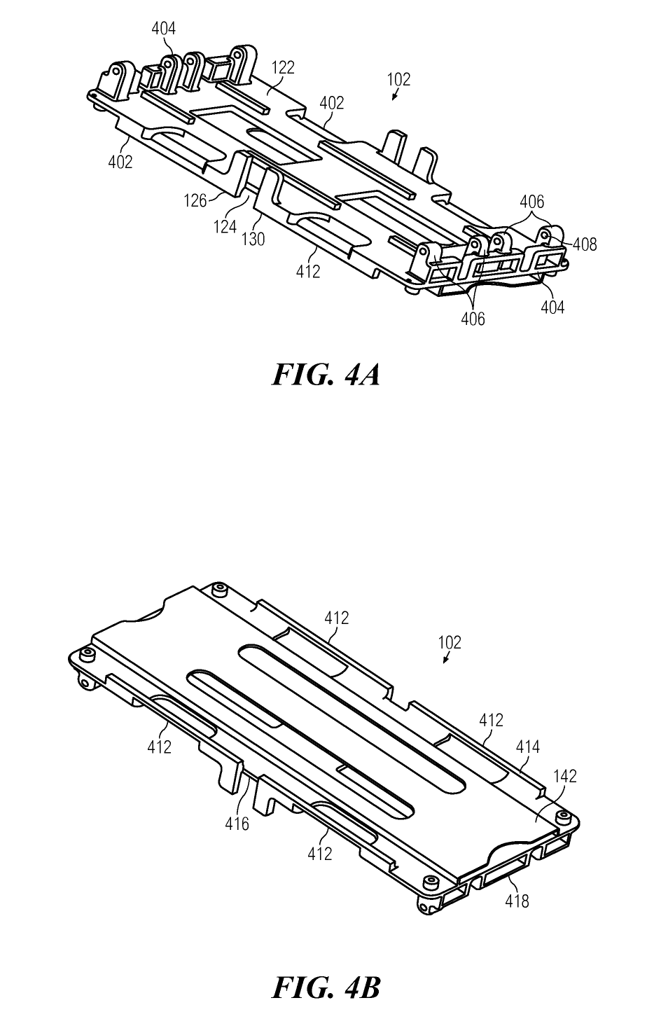

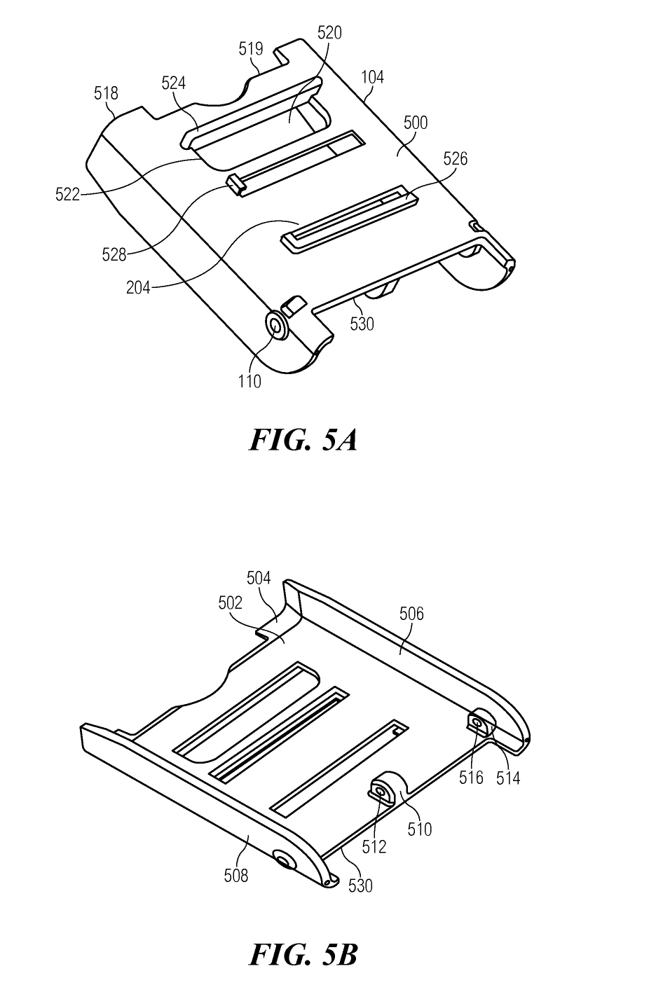

As noted above, the first and second side parts 104, 106 form side walls of the semiconductor tray carrier 100 when in the deployed positions 108a, 114a. In this configuration, the component parts of semiconductor tray carrier 100, i.e., the base part 102, first side part 104 and second side part 106, generally define a rectangular cuboid (at least partially) absent side walls along the long edges, which will be discussed in more detail with reference to FIG. 4. Thus, the component parts of the semiconductor tray carrier 100 can be considered to define an internal, or “carrier” volume 120 for receiving semiconductor trays. The semiconductor tray carrier 100 may be sized to carry semiconductor trays of known dimensions. When placed inside the tray carrier 100, the semiconductor trays will rest an upper surface 122 of base part 102 and external edges of the semiconductor trays (not shown in FIG. 1) will abut against the inner sides of the side parts 104, 106 (see FIG. 5). The upper surface 122 need not be completely flat although it may define, in whole or in part, the generally planar portion of the base part 102. The upper surface 122 also may be fairly irregular, comprising projections, indentations and/or apertures therethrough as better illustrated in, for example, FIGS. 4A and 4B, discussed below. All that is required is an area/surface for semiconductor trays to be disposed thereon when stored in the semiconductor tray carrier 100.

In the embodiment of FIG. 1, semiconductor tray carrier 100 also comprises a guide 124 for a packing restraint (not shown in FIG. 1) for semiconductor trays disposed within the semiconductor tray carrier 110 (in the carrier volume 120). The guide 124 is formed from a first projection 126 in the form of a lug extending upwards from the base 102 and having an inside face 128 rising at 90 degrees, or thereabouts. The guide 124 is also formed from a second projection/lug 130 extending upwards from the base 102 and having an inside face 132 directly opposed the inside face 128 of the lug 126. In this embodiment, the lug 130 also extends upwards from the base 102 at 90 degrees, or thereabouts. A volume 134 between inside the faces 128, 132 defines a channel in which a packing restraint can be placed for restraining semiconductor trays disposed inside the semiconductor tray carrier 100. Thus, the volume/channel 134 acts as a guide for the packing restraint.

When disposed within the tray carrier 100 and upon the surface 122 of the base part 102, the semiconductor trays also may abut an inside surface of the packing restraint guide 124. Therefore, and in conjunction with the packing restraint (when installed), the semiconductor tray carrier 100 requires only two side walls: side parts 104, 106 in their respective deployed positions 108a, 114a. This provides the added advantage of increased visibility of semiconductor trays within the semiconductor tray carrier 100, as mentioned above.

In the embodiment of FIG. 1, the components of semiconductor tray carrier 100 are sized so that, when the first and second side parts 104, 106 are arranged in the stowed positions 108b, 114b, edges 136, 138 of the first and second side parts 104, 106 respectively which are distal the pivots 110, 116 do not extend to cover the lugs 126, 130 of the packing restraint guide 124. A gap 140 is defined by the separation of the edges 136, 138.

In this embodiment, the semiconductor tray carrier 100 also comprises at least one projection (not illustrated in FIG. 1) extending from an underside of the base part 102, which will be discussed in greater detail with reference to FIG. 4.

Alternatively, FIG. 1 can be considered to illustrate a semiconductor tray carrier 100 comprising: a base part 102 having a first generally planar portion 122 for a semiconductor tray to be disposed thereon; a first side part 104 coupled with the base part 102 at a first hinge (or pivot) 110, the first side part 104 having a second generally planar portion forming a first side wall 144; and a second side part 106 coupled with the base part 102 at a second hinge 116, the second side part 106 having a third generally planar portion forming a second side wall 146; wherein each of the first and second side parts 104, 106 is collapsible towards the base part 102 about the first and second hinges 110, 116 respectively to lie in respective stowed positions 108b, 114b, wherein, in the stowed positions 108b, 114b, the first generally planar portion 122, the second generally planar portion 144 and the third generally planar portion 146 all lie in planes generally parallel to one another.

Of course, it will be appreciated the embodiment of FIG. 1 is exemplary only and that various modifications may be made to the construction and configuration. For instance, in one alternative embodiment, the three principal parts, i.e., the base part 102, first side part 104 and a second side part 106 may be integrally molded with one another. In such a configuration, the or each of the first and second side parts 104, 106 may be arranged to move between the respective stored and deployed positions by pivoting about a hinge defined by a thinner section of material joining the respective side parts 104, 106 with the base part 102. In this regard, the side parts are arranged to pivot about this thinner section relative to the base part.

In a further alternative arrangement (not illustrated), the base part 102 has additional side walls extending vertically upwards from the base part at the edges thereof, preferably the shorter edges such as edges 404 of FIG. 4. These additional side walls have cavities for the side parts 104, 106 to be withdrawn therewithin. Thus, when in the withdrawn position inside the side walls, the side parts are in the stowed position (and are “collapsible” to the stowed position) and when extending from the side walls, the side parts are in the deployed position to form at least a part of the side walls.

It will also be appreciated that the side parts 104, 106 need not form an entire wall section across the entire shorter sides (discussed in greater detail with reference to FIG. 4) of the base part 102. In embodiments of the invention, it is sufficient simply to provide one or more projections, such as a leg for the semiconductor trays to abut against, projecting from each of the short sides of the base part 102 which will serve as a wall part to help retain semiconductor trays disposed in carrier volume 120 in secure stacked formation. For example, these legs may be provided at one or more corners of the base part 102. If so desired, an additional wall section can be affixed to the one or more legs for added security. In one such alternative embodiment, four collapsible legs are provided, each pivotably fixed at corners of the base part 102.

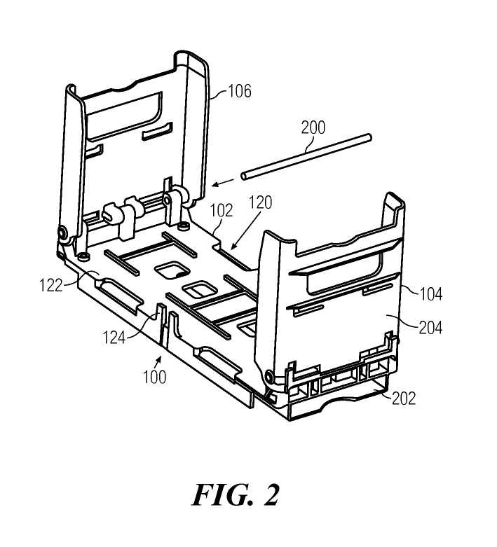

Turning now to FIG. 2, an elevated perspective view of the semiconductor tray carrier 100 of FIG. 1 is illustrated. Both of the side parts 104, 106 are arranged in their respective deployed positions 108a, 114a, to form side walls of the semiconductor tray carrier 100. The guide 124 for the packing restraint (not shown) may be more clearly viewed.

In this embodiment, the semiconductor tray carrier 100 also comprises one or more rods 200 forming part of the pivot, 110, 116 of FIG. 1 which will be described in more detail with reference to FIGS. 4 and 5.

The semiconductor tray carrier 100 also comprises a storage space accessible from outside of the carrier volume 120. The storage space may take any of several forms, and two possibilities are illustrated in FIG. 2. The first form of storage space comprises a pocket 202 which can be used, for example, to store documentation such as a shipping order for the semiconductor trays within the semiconductor tray carrier 100. The pocket 202 comprises a hollow volume in base the part 102 (e.g., “pigeonhole” style), for documents to be inserted therein.

A second form of storage space comprises a cardholder 204, described in more detail below with reference to FIG. 5. Thus, when the first and second side parts 104 and 106 are in the respective first and second deployed positions 108a, 114a, the semiconductor tray carrier 100 defines a carrier volume 120 for carrying semiconductor trays, and storage spaces 202, 204 accessible from outside of the carrier volume 120.

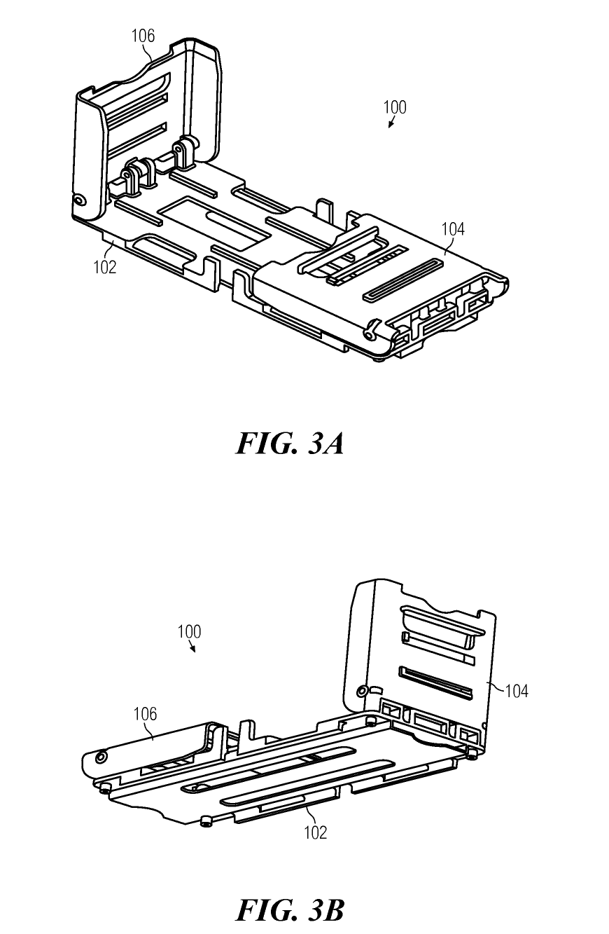

FIGS. 3A and 3B illustrate the semiconductor tray carrier 100 in two perspective views. FIG. 3A illustrates the semiconductor tray carrier 100 from an elevated perspective, i.e., looking “down” on the semiconductor tray carrier 100, with the first side part 104 disposed in the stowed position and the second side part 106 disposed in the deployed position. FIG. 3B illustrates the semiconductor tray carrier 100 from below, illustrating an underside of the base part 102, with the first side part 104 disposed in the deployed position 108a and the second side part 106 disposed in the stowed position 114b.

FIGS. 1 to 3 together illustrate a method of forming a semiconductor tray carrier, the method comprising: providing a base part; providing a first side part; providing a second side part; mechanically coupling the first side part with the base part, the first side part being movable between a first stowed position and a first deployed position in which the first side part extends from the base part to form a first side wall; and mechanically coupling the second side part with the base part, the second side part being movable between a second stowed position and a second deployed position in which the second side part extends from the base part to form a second side wall.

With such a method, those skilled in the art will realize that it is not essential for the individual steps of the method to be performed sequentially in the stated order. For instance, in embodiments where the individual components of the semiconductor tray carrier 100 are provided integrally molded with one another, the mechanical coupling of the side parts with the base part will take place during the molding process, such that the individual parts are provided integrally with one another.

FIGS. 4A and 4B illustrate in more detail the base part 102 of the semiconductor tray carrier 100. FIG. 4A illustrates the base part 102 from an elevated perspective, looking down at the base part 102. As can be seen, the base part 102 is generally rectangular in plan view having two long sides 402 and two shorter sides 404. The surface 122 defines a generally planar portion of flat surface for placing thereon semiconductor trays (not shown in FIG. 4).

The guide 124 for a packing restraint (not shown) and its respective lugs 126, 138 as discussed with reference to FIG. 1 may be viewed more clearly in FIG. 4A.

The underside surface 142 is also generally planar, e.g., flat, which facilitates secure placement on, say, a storage shelf. The base part 102 may also comprise one or more projections 412 extending from the underside 142 of base part 102, as noted above. Provision of the one or more projections 412 allows for minimal contact between the underside 142 of base part 102 and the, for example, storage shelf surface thereby minimizing problems that might otherwise be caused by friction of the underside 142 on the shelving unit accumulating or trapping dust. In FIG. 4B, the base part 102 comprises a total of four projections 412 each of which comprises a thin rail running partially along the underside 142 surface of the long sides 402 of the base part 102. The or each projection/rail 412 runs for almost half the length of each of the long sides 402 of base part 102, from a few millimeters inside the short side 404 at the corner where the long and short sides 402, 404 meet, to the inside faces 128, 132 of the lugs 126, 130 respectively of the guide 124 for a packing restraint. In this embodiment, the or each projection/rail 412 has a width of around 1 mm to 2 mm and has an underside 414 for contact with the shelving unit or other storage area on which the tray carrier 100 may be placed. The underside 414 of the rail 412 is displaced from the underside surface 142 of the base part 102, which means that the underside surface 142 of base the part 102 is displaced from the shelving unit (or other) surface thereby minimizing contact therewith.

The base part 102 also comprises a portion 418 for an abutting portion 530, best viewed in FIG. 5, of the or each side part 104, 106. This will be discussed below in greater detail with reference to FIG. 5.

The inside surfaces 128, 132 act to guide a packing restraint (not shown) to be applied when one or more semiconductor trays are disposed on the surface 122 of the semiconductor tray carrier 100. When in place, the packing restraint is wrapped tightly around the underside 142 of the base part 102 through the gap 134, such that the restraint presses firmly against the edge 416 of the main body part 102 within the gap 134.

The base part 102 comprises a main part having a number of components projecting therefrom. At or near the or each short side 404, lugs 406 project upwardly from the surface 122 of the base part 102. The lugs 406 have holes 408 for one or more of the rods 200 to be inserted therethrough. As will be discussed in more detail with reference to FIG. 5, the or each rod 200 is also disposed through holes in the or each side part 104, 106 and, the or each side part 104, 106 and the base part 102 are then movable relative one another about the pivots 110, 116.

FIGS. 5A and 5B provide perspective views of one of the side parts 104, 106 of the semiconductor tray carrier 100. FIG. 5A illustrates a perspective view of an outside 500 of the side part (104 or 106). FIG. 5B illustrates a perspective view of an inside of the side part (104 or 106). The side part 104 comprises a generally planar portion or flat surface 502 (FIG. 5B) against which external edges of the semiconductor trays may abut when disposed within the semiconductor tray carrier 100. The flat surface 502 terminates at a fold 504 where folded parts 506 extend away from the flat surface 502 at 90 degrees. The folds 504 define corners in which external corners of the semiconductor trays may securely rest, subject to the semiconductor trays being appropriately sized. The side part 104 also comprises a lug 510 projecting from the flat surface 502 at about the midpoint thereof, the lug 510 having a hole 512 therethrough. The side part 104 further comprises one or more lugs 514, disposed at or near the folds 504. The or each lug 514 has a hole 516 therethrough, which may be a blind hole, terminating inside the lug 514. Alternatively, the hole 516 may extend all the way through the lug 514. In the embodiment of FIG. 5B, the lug 514 is positioned at fold the 504 so that the lug 514 abuts the folded portion 506 and the hole 516 terminates at the inside surface of the folded portion 506. Although not shown in FIG. 5B, a corresponding lug having a whole therethrough may also be disposed adjacent to the folded portion 508.

The holes 512, 516 of the lugs 512, 514 are co-aligned with the holes 408 of the lugs 406 of the base part 102 (see FIG. 4A). A rod, such as the rod 200 of FIG. 2, is disposed through the co-aligned holes, the holes/lugs and the rod(s) acting as the pivot such as pivots 110, 116 illustrated in FIG. 1. The rods may be fixed by, for example, C-clips. That is, the base part 102 comprises a hole 408 for co-alignment with a hole 512, 516 of at least one of the first and second side parts 104, 106 and the rod 200 is disposed in the holes, with the holes and the rod defining the pivot. In this regard, one or more rods 200 may be used but, in the present embodiment, a single rod 200 is disposed more or less along the length of the short side 404 of the base part 102 through the holes 406 and the holes 512, 516. In an exemplary alternative embodiment, two rods 200 are used: one rod disposed between the lugs 510 and 514 of the side part and in the holes 512, 516, and a second rod disposed between lug 510 and another lug (not shown) disposed adjacent the folded portion 508 of the side part and in the hole 512 and the hole of the lug adjacent the folded portion 508. As appropriate, the or each rod 200 is also disposed in the holes 406 in base part 102.

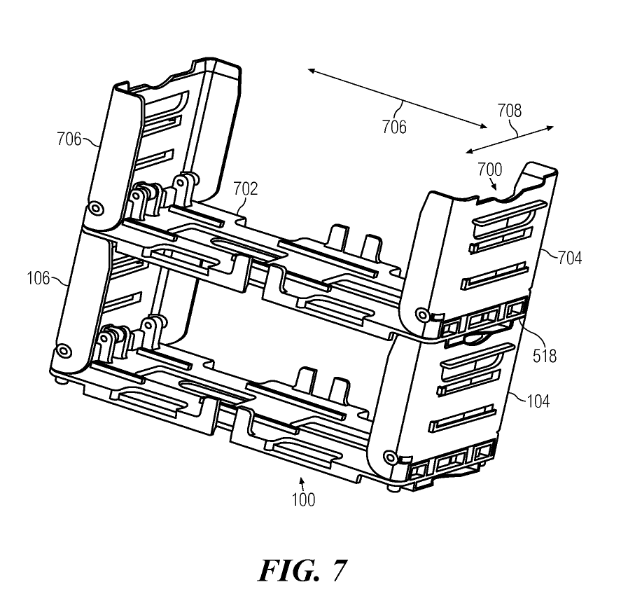

As shown in FIG. 5A, the side part 104/106 has an upper edge 518 distal the base part 102 when the side part 104/106 is in the deployed position 108a/114a. The upper edge 518 includes a recess 519 arranged to engage with a second semiconductor tray carrier to facilitate stacking of semiconductor tray carriers, one atop the other. This is best illustrated in FIG. 7, discussed below.

The or each side part 102, 104 may also comprise a handle formed from an aperture therethrough. In the current embodiment, the or each side part 102, 104 has an aperture 520 defined by an inner edge 522. A lip 524 projects outwards from the upper face of the aperture 520 to facilitate ease of use by an operator.

As noted above, the side part 102/104 also comprises a cardholder 204 that comprises a lower card-retention projection 526 projecting from the side part 104 for locating a bottom edge of a card (not shown) therein. The card can be slid into the cardholder 204 via an upper guide 528 for retaining the card in place.

The side parts 102, 104 also have a lower edge that defines the abutting portion 530 that abuts portion 418 of the base part 102. The abutting of these two parts when the side part 104/106 is in the deployed position 108a/114a inhibits over rotation of the side parts about the pivot 110/116 beyond the vertical or 90 degrees position. That is, at least one of the first and second side parts 104, 106 is arranged to move between the stowed position 108b, 114b and the deployed position 108a, 114a about the pivot 110, 116 through a range of angles 111, 117 and to extend from the base part 102 in the deployed position at a predetermined angle, and wherein the at least one of the first and second side parts 104, 106 comprises an abutting portion 530 for abutting the base part 102 in the deployed position to inhibit the at least one of the first and second side parts 104, 106 from moving beyond the deployed position 108a, 114a.

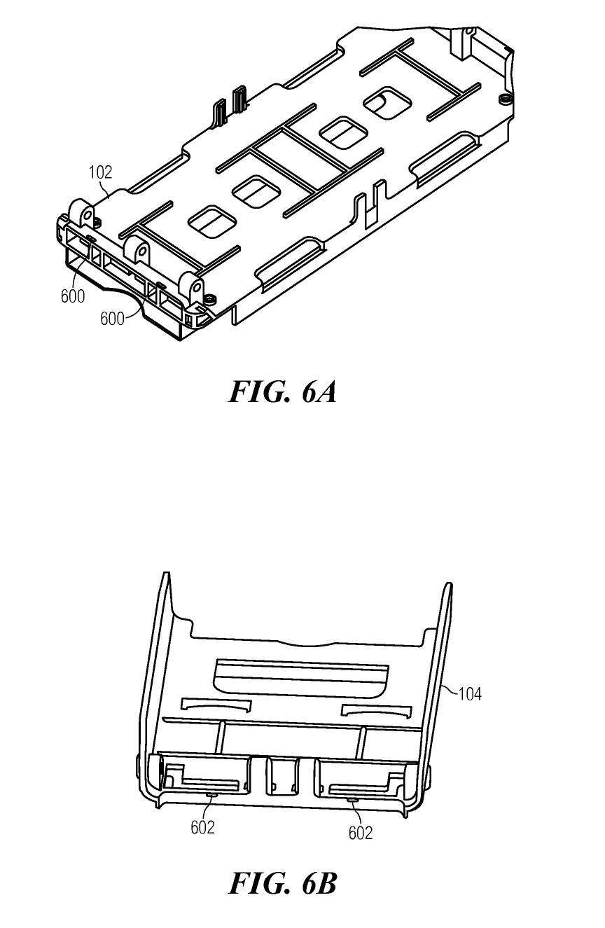

The semiconductor tray carrier 100 may also comprise at least one retention mechanism for retaining at least one of the first and second side parts in the deployed position. The retention need not be permanent fixing. One exemplary retention mechanism is illustrated in FIGS. 6A and 6B. Turning first to FIG. 6A, the base part 102 has one or more recesses 600 for receiving a corresponding one or more projections 602 in the side part 104 (FIG. 6B), the recesses 600 and projections 602 comprising the retention mechanism. When the side part is moved to the deployed position, for example pivoted about either of pivots 110, 116, the projections 602 engage with the recesses 600 to provide a retention or detent function which retains the side part at the deployed position. Of course, the arrangement may be reversed so that the one or more recesses are provided in the side part and the corresponding one or more projections are provided in the base part. So, the at least one retention mechanism comprises a protrusion in a first one of the side parts and the base part for engagement with a recess in a second one of the side parts or the base part.

As noted above, the semiconductor tray carrier 100 may be arranged to inhibit movement of the side part beyond the deployed position, but application of pressure on the side part by a user towards the stowed position may be sufficient to release the side part from the deployed position.

The above discussion concerning the detent mechanism of FIG. 6 is just one exemplary implementation and other types of retention mechanisms, including mechanisms for locking the side parts in the deployed position are also envisaged.

As mentioned above with reference to FIGS. 4 and 5, at least one of the first and second side parts 104, 106 comprises a recess 519 arranged to engage with a second semiconductor tray carrier to facilitate stacking of semiconductor tray carriers, one atop the other. This is best illustrated in FIG. 7, which illustrates the semiconductor tray carrier 100 having a second semiconductor tray carrier 700 disposed thereupon. The second semiconductor tray carrier 700 comprises a base part 702, a first side part 704 and a second side part 706. The individual parts of the semiconductor tray carrier 700 may correspond with the individual parts of the semiconductor tray carrier 100.

In the example of FIG. 7, the recess 519 illustrated in FIG. 5 of the side part of the semiconductor tray carrier 100 acts as an engagement portion which, when in the deployed position, is distal the base part, the engagement portion being for engaging with a part, for example a base of a second semiconductor tray carrier. In this example, the engagement portion or recess 519 engages with the base 702 of the second semiconductor tray carrier 700. As illustrated the engagement portion comprises the recess 519 in the edge 518 of the side part for engaging with the base part 702 of the second semiconductor tray carrier 700. Such an arrangement inhibits movement of the second semiconductor tray carrier 700 relative to the semiconductor tray carrier 100 in the directions shown by arrows 706 and 708, thereby lending itself to facilitating secure stacking of semiconductor tray carriers one atop the other. Although FIG. 7 illustrates two tray carriers 100 and 700 stacked while both are in the deployed position (sides extending vertically), when the tray carriers 100, 700 are in the stowed position (sides in horizontal plane), the trays 100, 700 require very little space for storage.

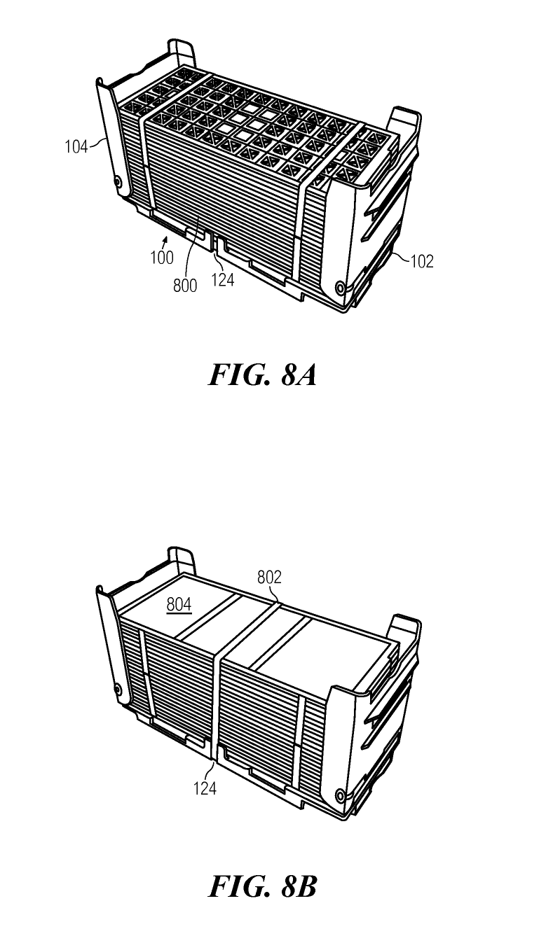

Turning to FIG. 8, a method of packing semiconductor trays in a semiconductor tray carrier will now be discussed. A semiconductor tray carrier 100 is placed at an operating station (see FIG. 8A). Plural semiconductor trays 800 are stacked within the carrier volume (carrier volume 120 FIG. 1). As discussed above, the semiconductor tray carrier 100 may be sized for the known dimensions of the semiconductor trays 800 so that the edges of the short side of the semiconductor trays abut against the inner surfaces of the side parts 102, 104 and that the edges of at least the lower semiconductor trays in the stack abut against the guide 124 for the packing restraint.

Therefore, FIG. 8 illustrates a method of packing semiconductor trays 800 in a semiconductor tray carrier 100, the semiconductor tray carrier 100 comprising: a base part 102; a first side part 104 arranged to move between a first stowed position and a first deployed position in which the first side part extends from the base part to form a first side wall part; and a second side part arranged to move between a second stowed position and a second deployed position in which the second side part extends from the base part to form a second side wall part; the method comprising: moving the first side part to the first deployed position and the second side part to the second deployed position, the base part, first side wall part and second side wall part defining a carrier volume 120 for carrying semiconductor trays 800; and placing a plurality of semiconductor trays 800 within the carrier volume 120.

The semiconductor tray carrier 100 may also include a separate tray cover 804 (FIG. 8B) that can be placed on top of the stack of semiconductor trays 800. A packing restraint 802 is then placed through guide 124 for securely fixing the semiconductor trays in the carrier volume of the semiconductor tray carrier. That is, the method of packing may also further comprise placing a packing restraint 802 around the plurality of semiconductor trays within the carrier volume, the placing of the packing restraint being performed using the guide 124 for the packing restraint on the base part 102. Additionally, and as illustrated, the method further comprises placing a tray cover 804 on the semiconductor tray carrier 100, the packing restraint 802 also been placed around the tray cover 804. In the exemplary embodiment of FIG. 8B, the tray cover 804 is placed “on the semiconductor tray carrier” in the sense that it is placed upon the semiconductor trays within the semiconductor tray carrier, but alternative arrangements where the tray cover 804 is placed directly on the semiconductor tray carrier or a part thereof is also envisaged. The semiconductor tray carrier 100, complete with a stack of semiconductor trays stored therewithin, may then be removed from the workstation and, for example, transported to a next workstation. Information relating to the next workstation or end destination may be conveniently located in the storage pocket 202 or cardholder 204.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

1. A semiconductor tray carrier, comprising:
a base part;
a first side part arranged to move between a first stowed position and a first deployed position in which the first side part extends from the base part to form a first side wall part; and
a second side part arranged to move between a second stowed position and a second deployed position in which the second side part extends from the base part to form a second side wall part.

2. The semiconductor tray carrier of claim 1, wherein at least one of the first and second side parts is arranged to lie in contact with the base part when in the stowed position.

3. The semiconductor tray carrier of claim 1, wherein at least one of the first and second side parts is arranged to move between the deployed position and the stowed position by pivoting relative to the base part about a pivot.

4. The semiconductor tray carrier of claim 3, wherein the base part comprises a hole for co-alignment with a hole of the at least one of the first and second side parts, the semiconductor tray carrier further comprising a rod disposed in the holes, the holes and the rod defining the pivot.

5. The semiconductor tray carrier of claim 3, wherein the at least one of the first and second side parts is arranged to move between the stowed position and the deployed position about the pivot through a range of angles and to extend from the base part in the deployed position at a predetermined angle, and wherein the at least one of the first and second side parts comprises an abutting portion for abutting the base part in the deployed position to inhibit the at least one of the first and second side parts from moving beyond the deployed position.

6. The semiconductor tray carrier of claim 1, further comprising at least one retention mechanism for retaining at least one of the first and second side parts in the deployed position.

7. The semiconductor tray carrier of claim 6, wherein the at least one retention mechanism comprises a protrusion in a first one of the side parts and the base part for engagement with a recess in a second one of the side parts or the base part.

8. The semiconductor tray carrier of claim 1, wherein the base part comprises at least one projection extending from an underside of the base part.

9. The semiconductor tray carrier of claim 1, wherein at least one of the first and second side parts comprises an engagement portion which, when in the deployed position, is distal the base part, the engagement portion being for engaging with a part of a second semiconductor tray carrier.

10. The semiconductor tray carrier of claim 9, wherein the engagement portion comprises a recess in an edge of the at least one of the first and second side parts for engaging with a base of the second semiconductor tray carrier.

11. The semiconductor tray carrier of claim 1, wherein the base part comprises a guide for a packing restraint for semiconductor trays disposed within the semiconductor tray carrier.

12. The semiconductor tray carrier of claim 1, wherein at least one of the first and second side parts comprises a handle, the handle comprising an aperture through the at least one of the first and second side parts.

13. The semiconductor tray carrier of claim 1, wherein, when the first side part and the second side part are in the respective first and second deployed positions, the semiconductor tray carrier defines a carrier volume for carrying semiconductor trays, and the semiconductor tray carrier further comprises a storage accessible from outside of the carrier volume.

14. The semiconductor tray carrier of claim 1, further comprising a separate tray cover.

15. A method of forming a semiconductor tray carrier, the method comprising:
providing a base part;
providing a first side part;
providing a second side part;
mechanically coupling the first side part with the base part, the first side part being movable between a first stowed position and a first deployed position in which the first side part extends from the base part to form a first side wall; and
mechanically coupling the second side part with the base part, the second side part being movable between a second stowed position and a second deployed position in which the second side part extends from the base part to form a second side wall.

16. A method of packing semiconductor trays in a semiconductor tray carrier, the semiconductor tray carrier comprising:
a base part;
a first side part arranged to move between a first stowed position and a first deployed position in which the first side part extends from the base part to form a first side wall part; and
a second side part arranged to move between a second stowed position and a second deployed position in which the second side part extends from the base part to form a second side wall part;
the method comprising:
moving the first side part to the first deployed position and the second side part to the second deployed position, the base part, first side wall part and second side wall part defining a carrier volume for carrying semiconductor trays; and
placing a plurality of semiconductor trays within the carrier volume.

17. The method of claim 16, further comprising placing a packing restraint around the plurality of semiconductor trays within the carrier volume, the placing of the packing restraint being performed utilizing a guide for the packing restraint on the base part.

18. The method of claim 17, further comprising placing a tray cover on the semiconductor tray carrier, the packing restraint also being placed around the tray cover.
